(19) United States
(12) Patent Application Publication
(10) Pub. No.: US 2015/0171673 A1
(43) Pub. Date: Jun. 18, 2015

(54) SYSTEM AND METHOD FOR RETAINING ROTOR STRUCTURE IN SYNCHRONOUS RELUCTANCE MACHINE

(71) Applicant: GENERAL ELECTRIC COMPANY, Schenectady, NY (US)

(72) Inventors: Philip Michael Cioffi, Schaghticoke, NY (US); James Pellegrino Alexander, Ballston Lake, NY (US); Patel Bhageerath Reddy, Niskayuna, NY (US)

(73) Assignee: GENERAL ELECTRIC COMPANY, Schenectady, NY (US)

(21) Appl. No.: 14/106,129

(22) Filed: Dec. 13, 2013

(51) Int. Cl. H02K 1/24; H02K 15/02; H02K 1/27

(52) U.S. Cl. CPC H02K 1/246; H02K 1/27; H02K 15/024

(57) ABSTRACT

A rotor assembly that includes at least one integral non-magnetic rotor retaining structure comprising a plurality of individual rotor retaining discs, the discs having predefined slots; and a plurality of magnetic segments retained within the slots of the discs of the respective integral non-magnetic rotor retaining structure.

### BACKGROUND

This disclosure relates generally to synchronous reluctance machines and specifically to rotor structures of synchronous reluctance machine.

A synchronous reluctance machine has a stator and a rotor supported in the inner periphery of the stator, is capable of being locally excited and is structurally the same as the stator of a common induction machine. Generally, the synchronous reluctance machine is well known as a motor, which is simply structured and does not need electric current carrying conductors or permanent magnets in the rotor. For example, the conventional induction machine comprises a machine body serving as a casing, a stator arranged along an inner circumferential surface of the machine body and an AC squirrel cage rotor rotatably arranged based on a rotational shaft at the center of the stator. The stator is formed of a lamination structure of various compositions of silicon steel and is provided with a plurality of teeth therein. A number of slots are formed between the teeth with a certain interval and the coil is wound on the teeth through the slots.

The synchronous reluctance rotor generally includes a plurality of rotor sections formed of alternating magnetic and non-magnetic components stacked axially and secured to a shaft. The core has a central axial bore for receiving a shaft. The laminations or laminated sections are inserted between radially extending arms of the core that are formed with a smooth, arcuate recess therebetween. The laminations are secured in the recesses by means of radial fasteners that secure radially opposing rotor sections to the core. The rotor sections are also secured together by end flanges and radial fasteners. The end flanges are cup-shaped members with an axially extending outer rim that is disposed about the outermost periphery of the laminations. The radial fasteners extend through the end flanges and core to secure the end flanges to the rotor. The rotor laminations may also be bonded to one another and to the core using an epoxy or other adhesive material.

Existing synchronous reluctance machines are mechanically and structurally limited because, traditionally, one set of designs uses axial laminations of various shapes and sizes assembled to make a rotor. In such examples, typically adhesives are used to retain the laminations. The non-uniformity of lamination parts poses an assembly problem for such designs. Further, it is an engineering requirement to resist the reactive centrifugal forces on the laminations and thereby reduce the leakage in magnetic flux.

Further, another set of traditional designs uses axially stacked laminations, having iron bridges to retain the laminations. These iron bridges have high leakage making these machines power deficient. Prior attempts in the past to remedy this problem have considered placing non-magnetic support notches between the arcuate lamination layers, while using non-magnetic discs at either ends of the machine to retain the support notches. Such an attempt typically uses similar shaped support notches that reduces complexity but raises several new manufacturing related issues.

Therefore there is need to improved mechanical structure with enhanced torque density and higher resistance to centrifugal force in the laminations.

### BRIEF DESCRIPTION

The disclosed technology is a rotor assembly that includes at least one integral non-magnetic rotor retaining structure comprising a plurality of individual rotor retaining discs, the discs having predefined slots; and a plurality of magnetic segments retained within the slots of the discs of the respective integral non-magnetic rotor retaining structure.

In another embodiment, the disclosed technology is a synchronous reluctance machine that includes a stator; a rotor shaft operationally disposed within the stator; a plurality of non-magnetic segments; a plurality of magnetic segments forming a rotor about the rotor shaft; and a plurality of non-magnetic segments integrated into a rotor retaining structure configured to retain the plurality of magnetic segments.

In yet another embodiment, the disclosed technology is a synchronous reluctance machine that includes a stator; a rotor shaft operationally disposed within the confines of the stator; a plurality of selected laminated magnetic segments arranged to form a rotor about the rotor shaft; and an integral rotor retaining structure with a plurality of non-magnetic segments having varying sizes, shapes and thicknesses.

In a further embodiment, the disclosed technology is a method for assembling synchronous reluctance machine that includes forming a rotor, assembling the rotor onto a rotor shaft; and providing a stator and operationally disposing the rotor and the rotor shaft therein. The step of forming a rotor includes providing a non-magnetic rotor retaining structure; and retaining a plurality of selected laminated magnetic segments disposed on the non-magnetic rotor retaining structure.

The above described and other features are exemplified by the following figures and detailed description.

### BRIEF DESCRIPTION OF THE DRAWINGS

Referring now to the figures wherein the like elements are numbered alike:

FIG. 1 illustrates an end view diagram of an exemplary embodiment of a synchronous reluctance machine;

FIG. 2 illustrates the alternating layers of non-magnetic material and the laminated segments, according to one embodiment;

FIG. 3 illustrates a cross-section of FIG. 1 to further illustrate the stacking of the non-magnetic material and the laminated segments in the axial direction, according to one embodiment;

FIG. 4 illustrates the non-magnetic material in both the radial and axial variations, according to one embodiment;

FIG. 5 is a process flow chart illustrating a method for assembling a synchronous reluctance machine, according to one embodiment.

### DETAILED DESCRIPTION

The disclosed technology relates to a rotor structure used in a synchronous reluctance machine. According to one embodiment, the rotor is formed from a plurality of magnetic segments that are retained into the desired shape by a retaining structure that allows the magnetic segments to be inserted for easy assembly.

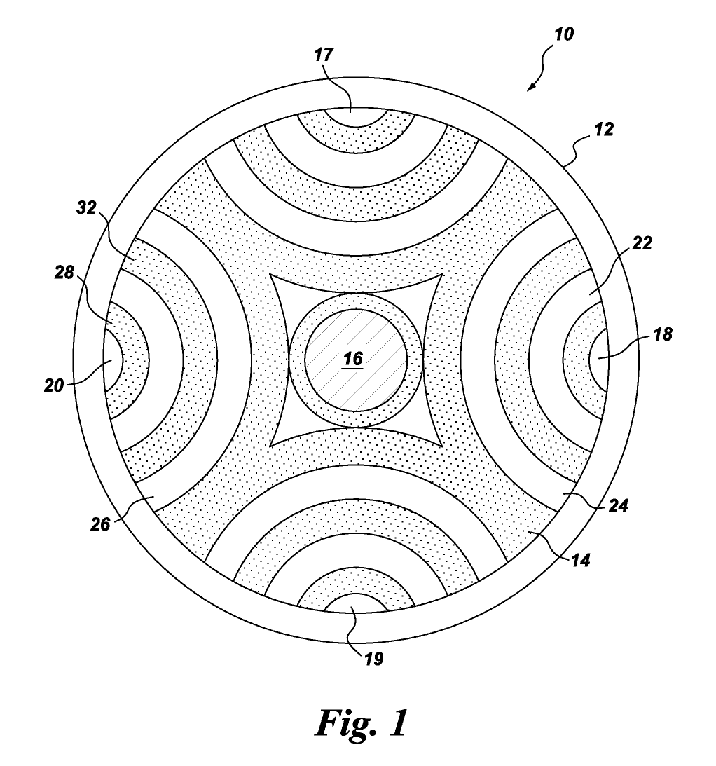

FIG. 1 illustrates an end view perspective of an exemplary embodiment of a synchronous reluctance machine. Referring to FIG. 1, synchronous reluctance machine 10 has a stator 12 and a selectively shaped rotor 14. The rotor 14 is rotatably mounted on rotor shaft 16. The stator 12 has a plurality of slots sized to receive armature windings. The selectively shaped rotor 14 of the synchronous reluctance machine 10 is configured in FIG. 1, as a four-pole machine with poles 17, 18, 19 and 20. It is understood that the synchronous reluctance machine 10 may, if desired, be configured with a different number of poles. For example, synchronous reluctance machine 10 has four poles but for design reasons or performance requirements the synchronous reluctance machine may have six identical poles. The configuration illustrated in FIG. 1, is for illustration purposes only and is not drawn to scale. Each individual pole 17, 18, 19, and 20 of the synchronous reluctance machine 10, is of similar construction according to one embodiment.

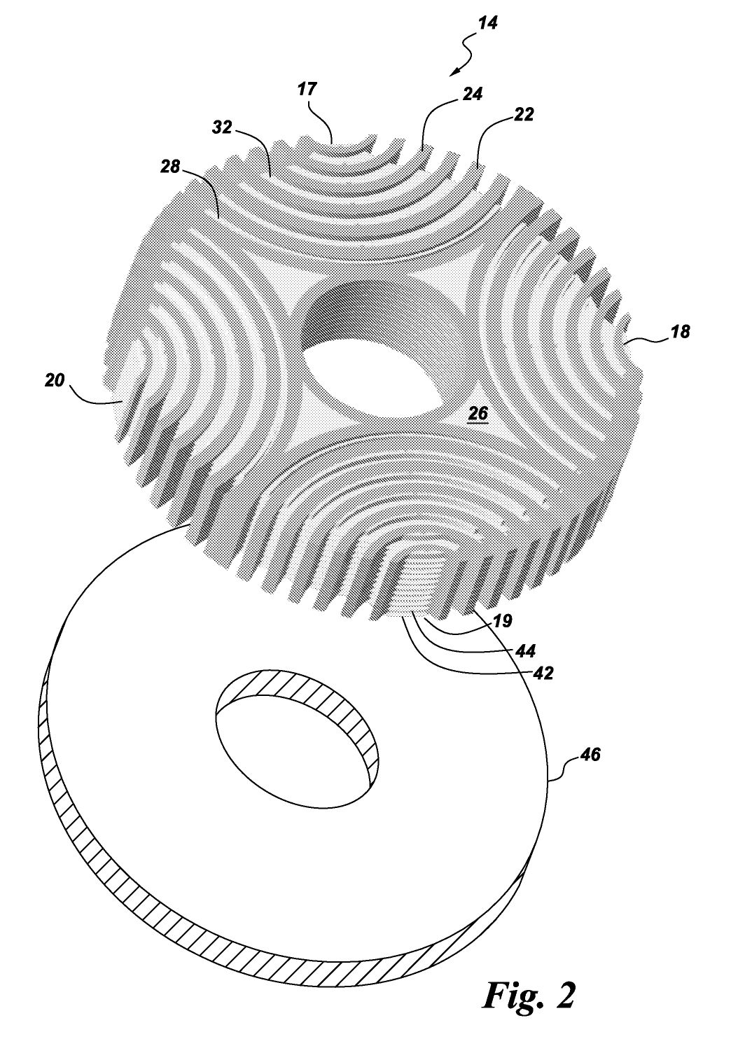

FIG. 2 shows a detailed perspective view of the rotor 14. An exemplary pole 17 of rotor 14 is constructed from a plurality of laminated magnetic segments 28, 32, and so on. The laminated magnetic segments 28, 32, and so on, are only exemplary. The number of laminated magnetic segments may vary depending on the design criteria of the synchronous reluctance machine. Further, the laminated magnetic segments 28, 32, and so on, may, if desired, be silicon steel or any other convenient, preferably magnetic, material. Each laminated magnetic segment is separated from the subsequent magnetic laminated segment by an arrangement of a number of non-magnetic segments. In one example the laminated magnetic segments are separated by the non-magnetic segments such as oriented axially, radially and circumferentially at the proper gap for optimal design. The plurality of non-magnetic segments forms the rotor retaining structure 26.

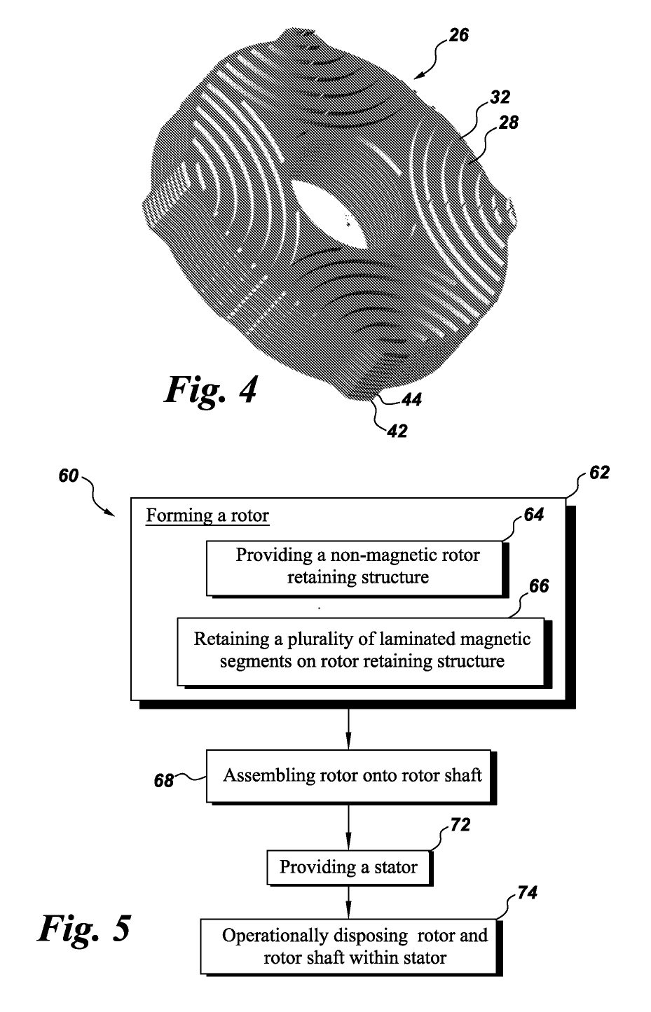

Referring to FIG. 1 and FIG. 2, the non-magnetic rotor retaining structure 26 is made of multiple non-magnetic segments according to one embodiment. In a further embodiment the non-magnetic rotor retaining structure 26 is an integrated structure such as shown in FIG. 4. The multiple non-magnetic segments in one example are designed to extend in the axial, radial, or circumferential directions. In case of a multiple-segment design, the typical thickness of a single magnetic segment is designed in consideration of optimal ease of assembly, as per various theories of design. The specific construction and structure of the rotor retaining structure 26 retains, assembles and supports the laminated magnetic segments 28, 32, and so on. Although only one rotor retaining structure 26 has been described above, there may be more than one rotor retaining structures 26 in other embodiments of the disclosure. In such embodiments, the several rotor retaining structures 26 are typically mounted on the rotor shaft 16 and assembled in series.

In one embodiment, the non-magnetic segments are designed as a number of intermediate discs to support the laminated magnetic segments 28, 32, and so on, in the axial direction. FIG. 2 illustrates the stacking of such non-magnetic intermediate discs 42, 44, and so on. Referring to FIG. 2, Rotor pole 17, may, if desired, contain a number of intermediate discs 42, 44, and so on. Any number of intermediate discs may form rotor pole 17. However, all of the poles 17, 18, 19 and 20 of the synchronous reluctance machine 10 preferably have the same number of intermediate discs. For example, if pole 17 had four intermediate discs then poles 18, 19 and 20 would also have four intermediate discs. The top surfaces of the poles 17, 18, 19 and 20 are rounded and smooth to conform to the inner portion of stator 12.

In another embodiment, the non-magnetic segments are designed as a number of notches formed on the intermediate discs to support the laminated magnetic segments in the radial and circumferential directions. FIG. 2 illustrates such separation of the laminated magnetic segments 28, 32, and so on, in the radial and circumferential directions by a number of non-magnetic notches 22, 24, and so on, formed on the intermediate discs 42, 44, and so on. In yet another embodiment, the non-magnetic segments 22, 24, and so on, may be grooves (instead of notches) cut on the intermediate discs 42, 44, and so on.

Whether in the form of notches or grooves, the non-magnetic segments 22, 24, and so on, may, if desired, be any convenient shape or size to separate the laminated segments. Depending on the design criteria of the synchronous reluctance machine the non-magnetic segments 22, 24, may be of varying size within the rotor pole structure. For example, the non-magnetic segments 22, 24, of exemplary pole 17 are all the same size, have an elongated shape and traverse the axial length of each associated arcuate structure. The non-magnetic segments 22, 24, and the rotor retaining structure 26, in one example are manufactured from a non-ferromagnetic material that provides high strength, particularly at higher temperatures. Examples of such non-ferromagnetic materials include materials such as Inconel, AM 350 or 17-4PH.

Referring again to FIG. 2, each rotor pole 17, 18, 19 and 20 is retained by an end flange 46 that surrounds the rotor 14. The end flange 46 is illustrated in FIG. 2 adjacent to rotor retaining structure 26. For any given rotor retaining structure 26 there are only two end flanges that hold laminated segments 28, 32, and so on, non-magnetic segments 22, 24, and so on, and the intermediate discs 42, 44, and so on, in place. The end flange 46 has one surface machined to fit the end portions of the laminated segments 28, 32, and so on, non-magnetic segments 22, 24, and so on, and intermediate discs 42, 44, and so on. A portion of an individual end flange 46 is affixed to the rotor shaft 16, FIG. 1. In total, for each pole 17, 15, 16 and 17 there are two end flanges with a portion of each connected to the rotor shaft 16. All of the poles share round end flanges. Thus, the network of non-magnetic support elements (end flanges, intermediate discs, notches and grooves) supports the rotor pole segments radially, axially and circumferentially. In addition, provide a structure for assembly and retaining mechanism for the laminated segments.

The introduction of non-magnetic material as a retaining structure allows for minimizing or completely removing the iron bridges or bolts typically used in traditional design of rotors for electric machines, thereby improving the torque density of these machines. Further, by placing the non-magnetic material between the laminations in the rotor, the non-magnetic material improves the mechanical structure by resisting the centrifugal force in the laminations. Overall, the non-magnetic material helps overcome the problem of assembly and improves the torque density in machines.

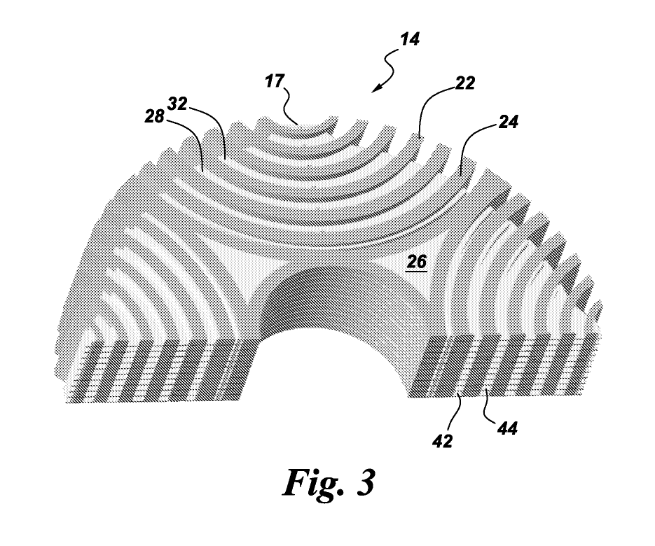

FIG. 3 shows a cross-section of FIG. 1 to further illustrate the stacking of the non-magnetic material and the laminations in the axial, radial and circumferential directions. FIG. 4 shows the non-magnetic Rotor retaining structure in axial, radial and circumferential. The arcuate laminates 28, 32, and so on, may, if desired, be any selected number depending on the design criteria for the machine. The spacing between the laminates is controlled by the size of non-magnetic notches (or grooves) 22, 24, and so on. The size and shape of the non-magnetic notches (or grooves) 22, 24, and so on, are selectable depending on the design criteria of the synchronous reluctance machine. The physical geometry of the laminates may, if desired, be selectable. Examples of selectable physical geometries of laminates are near parabolic shaped laminate and the special shaped laminate. The special shaped laminate is substantially arcuate with the end portions and the bottom portion enlarged. In each case the laminate is designed to meet certain design criteria and the designer of the synchronous reluctance machine 10 may, if desired, mix or match and vary the size of the notches to meet selected design criteria. As the physical geometries of the laminates change so do the size and shape of the non-magnetic notches (or grooves) 22, 24, and so on, intermediate discs 42, 44 and so on, to accommodate the size and shape of the laminates. Typically, the arcuate laminations may be made of one single segment (as in a crescent) or of multiple segments (as in a U-shape). Further, the gap between the laminated segments may, if desired, vary to accommodate a wider or narrower notch on the surface of the rotor retaining structure. If the gap between the laminates changes their associated end notches, intermediate discs 44 and change accordingly.

As delineated above the synchronous reluctance machine 10 has axially stacked magnetic segments 28, 32, and so on, which significantly reduce the core losses. Each of the lamination segments is “locally” supported by non-magnetic notches (or grooves) 22, 24, and so on, intermediate discs 42, 44, and so on, and end flanges 46 so that its mechanical load is not wholly transferred to the next one. This makes the rotor more robust and allows for higher speed and larger diameter designs. Also, intermediate discs 42, 44, and so on support the lamination segments magnetic segments 28, 32, and so on axially, radial and circumferentially. These notches (or grooves) with the spacing among the lamination segments and the local support structure provide for assembly of the whole rotor from its constituent parts and help in structurally retaining the rotor in a very efficient manner.

FIG. 5 is a process flow chart illustrating a method 60 for assembling synchronous reluctance machine 10 of FIG. 1. The method includes forming a rotor as in step 62 by providing a non-magnetic rotor retaining structure (26, FIG. 1-4) as in step 64 and retaining a plurality of selected laminated magnetic segments (28, 32, and so on, FIG. 1-4) on the non-magnetic rotor retaining structure as in step 66. The method also includes assembling a rotor (12, FIG. 1-4) onto a rotor shaft (16, FIG. 1) as in step 68. The method 60 further includes providing a stator as in step 24 and operationally disposing the rotor and the rotor shaft therein as in step 74.

In operation: the rotor shaft 16 along with poles 17, 18, 19 and 20 containing the laminated segments 28, 32, and so on, are rotatively disposed to the rotor which is supported by the inner peripheral surface of the stator 12 casing. Electrical AC power is supplied to the windings of the stator 12 and the rotor begins to rotate.

In one alternate embodiment, the disclosed technology may take the form commonly referred to as the “inside-out” configuration. In such a configuration, the axial laminations may form arcuate segments radially and the assembly of segments may be located radially outside of the stator 12. The stator 12 may then contain a plurality of windings and slots and may be located inside of the rotor 14. In yet another embodiment, the disclosed technology may be applied in such a way that the “inside-out” configuration is used to provide a double-sided machine. The axially stacked laminations, in one such design, can be used to form radially spaced segments that occupy space between an inner and an outer stator assembly (not shown). Conversely, a set of laminated segments may be assembled for rotating a structure radially inside the stator structure while other lamination segments are positioned radially outside the stator 12.

While the disclosed technology has been described with reference to an exemplary embodiment, it will be understood by those skilled in the art that various changes may be made and equivalents may be substituted for elements thereof without departing from the scope of the disclosed technology. In addition, many modifications may be made to adapt a particular situation or material to the teachings of the disclosed technology without departing from the essential scope thereof. Therefore, it is intended that the disclosed technology not be limited to the particular embodiment disclosed as the best mode contemplated for carrying out this disclosed technology, but that the disclosed technology will include all embodiments falling with the scope of the appended claims.

What is claimed is:

1. A rotor assembly, comprising
at least one integral non-magnetic rotor retaining structure comprising a plurality of individual rotor retaining discs, said discs having predefined slots; and
a plurality of magnetic segments retained within the slots of the discs of the respective integral non-magnetic rotor retaining structure.

2. The rotor assembly as recited in claim 2 comprising at least two integral non-magnetic rotor retaining structures axially assembled in series.

3. A synchronous reluctance machine, comprising:
a stator;
a rotor shaft operationally disposed within said stator;
a plurality of non-magnetic segments;
a plurality of magnetic segments forming a rotor about said rotor shaft; and
a plurality of non-magnetic segments integrated into a rotor retaining structure configured to retain said plurality of magnetic segments.

4. The synchronous reluctance machine as recited in claim 3, wherein said non-magnetic segments comprise a plurality of intermediate discs configured to retain said plurality of selected magnetic segments in axial direction.

5. The synchronous reluctance machine as recited in claim 4, wherein said non-magnetic segments further comprise at least one of: a plurality of notches and a plurality of grooves configured on said intermediate discs to retain said plurality of selected magnetic segments in at least one of: radial and circumferential directions.

6. The synchronous reluctance machine as recited in claim 3, wherein said rotor shaft is rotatably supported at an inner peripheral surface of said stator.

7. The synchronous reluctance machine as recited in claim 3, wherein said magnetic segments are arcuate and are radially positioned in an inside-out rotor and stator configuration.

8. The synchronous reluctance machine as recited in claim 3, wherein said magnetic segments are arcuate and comprise at least one of: single-segment configuration and multi-segments configuration and said magnetic segments are radially positioned in a double-sided rotor and stator configuration.

9. The synchronous reluctance machine as recited in claim 3, further comprising at least two end flanges mounted on said stator and said rotor shaft and configured to hold said plurality of magnetic segments and said rotor retaining structure together.

10. The synchronous reluctance machine as recited in claim 3, wherein rotor retaining structure is supported by the rotor shaft.

11. A synchronous reluctance machine comprising:
a stator;
a rotor shaft operationally disposed within the confines of said stator;
a plurality of selected laminated magnetic segments arranged to form a rotor about said rotor shaft; and
an integral rotor retaining structure with a plurality of non-magnetic segments having varying sizes, shapes and thicknesses.

12. The synchronous reluctance machine as recited in claim 11, wherein said non-magnetic segments comprise a plurality of intermediate discs configured to retain said plurality of selected magnetic segments in axial direction.

13. The synchronous reluctance machine as recited in claim 12, wherein said non-magnetic segments further comprise at least one of: a plurality of notches and a plurality of grooves configured on said intermediate discs to retain said plurality of selected laminated magnetic segments in at least one of: radial and circumferential directions.

14. The synchronous reluctance machine as recited in claim 11, wherein said rotor shaft is rotatably supported at an inner peripheral surface of said stator.

15. The synchronous reluctance machine as recited in claim 11, wherein said selected laminated magnetic segments are radially positioned in an inside-out rotor and stator configuration.

16. The synchronous reluctance machine as recited in claim 11, wherein said selected laminated magnetic segments are radially positioned in a double-sided rotor and stator configuration.

17. The synchronous reluctance machine as recited in claim 11, further comprising at least two end flanges mounted on said stator and said rotor shaft and configured to hold said plurality of selected laminated magnetic segments and said rotor retaining structure together.

18. A method for assembling synchronous reluctance machine comprising:
forming a rotor, comprising:
providing a non-magnetic rotor retaining structure;
retaining a plurality of selected laminated magnetic segments disposed on said non-magnetic rotor retaining structure;
assembling the rotor onto a rotor shaft; and
providing a stator and operationally disposing said rotor and said rotor shaft therein.

19. The method for assembling synchronous reluctance machine as recited in claim 18, wherein said retaining a plurality of selected laminated magnetic segments on said non-magnetic rotor retaining structure comprises retaining said plurality of selected laminated magnetic segments are axially disposed by a plurality of intermediate discs forming a part of said non-magnetic rotor retaining structure.

20. The method for assembling synchronous reluctance machine as recited in claim 19, wherein said retaining a plurality of selected laminated magnetic segments on said non-magnetic rotor retaining structure comprises retaining said plurality of selected laminated magnetic segments in at least one of: radial and circumferential directions by at least one of: a plurality of notches and a plurality of grooves formed on said intermediate discs.

21. The method for assembling synchronous reluctance machine as recited in claim 18 further comprising mounting at least two end flanges on said stator and said rotor shaft and holding said plurality of selected laminated magnetic segments and said rotor retaining structure together by said at least two end flanges.
